(19) United States
(12) Patent Application Publication
(10) Pub. No.: US 2026/0227335 A1
(43) Pub. Date: Aug. 6, 2026

(54) REDUCTION OF STRAY LIGHT NOISE IN OPTICAL RAMAN PROBE SENSORS

(71) Applicant: Merck Patent GmbH, Darmstadt (DE)

(72) Inventors: Renaud Puget, Bernin (FR); Frabrice Thomas, Saint Martin D'Heres (FR); Céline Duchemin, Montbonnot Saint Martin (FR); Célia Sanchez, Grenoble (FR); Laurent Jourdainne, Stutzheim Offenheim (FR)

(21) Appl. No.: 19/149,982

(22) PCT Filed: Feb. 2, 2024
(86) PCT No.: PCT/EP2024/052590

§ 371 Date: Jul. 22, 2025

(30) Foreign Application Priority Data
Feb. 3, 2023 (EP) 23305149.9

(51) Int. Cl. G01N 21/65; G01J 3/44

(52) U.S. Cl. CPC G01N 21/65; G01J 3/4412; G01N 2021/656; G01N 2201/064; G01N 2201/121

(57) ABSTRACT

A system and method for quantifying the stray light that enters a Raman optical sensor and removes this from the Raman spectrum is disclosed. One or more background noise measurements are performed by the Raman analyzer wherein the laser is disabled during these background noise measurements. One or more traditional signal acquisition measurements are then performed. The results from the background noise measurements and the traditional signal acquisition measurement are then processed. This results in a clean spectrum, where the background noise has been significantly reduced. In some embodiments, background noise measurements are performed before and after the traditional signal acquisition measurement and these noise measurements are averaged.

### FIELD

Embodiments of the disclosure relate to systems and methods to reduce stray light noise during the use of optical Raman probe sensors.

### BACKGROUND

In many applications, such as bioprocessing applications, it is important to carefully and accurately monitor the composition of materials. For example, in a bioreactor, it may be important to monitor the amounts of various molecules, such as glucose, lactate, glutamine, ammonium and others.

In many situations, this monitoring may be done using Raman spectroscopy. In Raman spectroscopy, a laser is used to direct light at a specific wavelength toward a target molecule. A photon reaches a molecule and excites it. Once the photon excites the molecule, there are several possible results. The most common is that the excitation is temporary and the molecule returns to its initial energy state. In this mode, the photon is scattered or redirected due to the interaction with the molecule. Further, the wavelength of the photon is unchanged since none of its energy was absorbed by the molecule. This phenomenon is referred to as Rayleigh scattering and does not provide any information about the molecule being analyzed.

In another mode, the molecule is excited by the photon and moves to a different vibrational or rotational state. If that new state is a higher energy state than the original energy state, then the photon loses energy, which results in a lower frequency. In this way, the total amount of energy is conserved. This mode is referred to as Stokes Raman scattering.

If that new state is a lower energy state than the original energy state, then the photon gains energy, which results in a higher frequency. This mode is referred to as anti-Stokes Raman scattering.

The Stokes Raman scattering and anti-Stokes Raman scattering may be used to generate a spectrum. This spectrum is usually displayed having a horizontal axis corresponding to wavenumber, which is typically defined as:

$$\frac{1}{{λ}_{0}} - \frac{1}{{λ}_{1}} ,$$

where λ₀ is the wavelength of the laser and λ₁ is the wavelength of the Raman scattered light. The vertical axis is used to represent intensity.

Importantly, each molecule, when excited, produces a unique spectrum that may be used to identify that molecule. Thus, the presence of different molecules may be determined using this approach.

The percentage of Stokes-Raman scattering as compared to Rayleigh scattering is very low and highly sensitive to noise. For example, ambient light from the sun or interior lighting may alter the Raman spectrum.

It would be advantageous if there were a system and method for reducing the effect of stray light noise that enters an optical Raman probe sensor on the Raman spectrum.

### SUMMARY

A system and method for quantifying the effects of the stray light that enters a Raman optical sensor and removes this stray light from the Raman spectrum is disclosed. One or more background noise measurements are performed by the Raman analyzer wherein the laser is disabled during these background noise measurements. One or more traditional signal acquisition measurements are then performed. The results from the background noise measurements and the traditional signal acquisition measurement are then processed. This results in a clean spectrum, where the background noise has been significantly reduced. In some embodiments, background noise measurements are performed before and after the traditional signal acquisition measurement and these background noise measurements are averaged.

According to some embodiments, a method of measuring Raman scattering is disclosed. The method comprises performing one or more noise acquisition measurements using a Raman analyzer, wherein the one or more noise acquisition measurements are performed while a laser within the Raman analyzer is disabled; performing one or more Raman signal acquisition measurements to create a Raman spectrum, wherein the Raman signal acquisition measurement is performed while the laser within the Raman analyzer is enabled; averaging the one or more noise acquisition measurements to create an average background noise spectrum; and processing the average background noise spectrum and the Raman spectrum to create a clean Raman spectrum. In some embodiments, the average background noise spectrum is subtracted from the Raman spectrum to create the clean Raman spectrum. In some embodiments, more than one Raman signal acquisition measurement is performed and results from the more than one Raman signal acquisition measurements are averaged to create the Raman spectrum. In some embodiments, at least one of the one or more noise acquisition measurements is performed before the Raman signal acquisition measurement. In some embodiments, at least one of the one or more noise acquisition measurements is performed after the Raman signal acquisition measurement. In some embodiments, more than one noise acquisition measurement is performed, and at least one of the noise acquisition measurements is performed before the Raman signal acquisition measurement and at least one of the noise acquisition measurements is performed after the Raman signal acquisition measurement.

According to some other embodiments, a system for measuring Raman scattering is disclosed. The system comprises an optical Raman probe sensor; a Raman analyzer, comprising an optical detector and a laser, the Raman analyzer in communication with the optical Raman probe sensor via a conduit; and a controller, wherein the controller: disables the laser and performs one or more noise acquisition measurements; enables the laser and performs one or more Raman signal acquisition measurements to generate a Raman spectrum; averages the one or more noise acquisition measurements to generate a noise spectrum; and processes the noise spectrum and the Raman spectrum to create a clean Raman spectrum. In some embodiments, the controller subtracts the noise spectrum from the Raman spectrum to create the clean Raman spectrum. In some embodiments, more than one Raman signal acquisition measurement is performed and the controller averages results from more than one Raman signal acquisition measurements to create the Raman spectrum. In some embodiments, the controller performs at least one of the one or more noise acquisition measurements before the Raman signal acquisition measurement. In some embodiments, the controller performs at least one of the one or more noise acquisition measurements after the Raman signal acquisition measurement. In some embodiments, the controller performs more than one noise acquisition measurement, and at least one of the noise acquisition measurements is performed before the Raman signal acquisition measurement and at least one of the noise acquisition measurements is performed after the Raman signal acquisition measurement.

### BRIEF DESCRIPTION OF THE FIGURES

For a better understanding of the present disclosure, reference is made to the accompanying drawings, which are incorporated herein by reference and in which:

FIG. 1 illustrates a bioreactor that includes a Raman probe sensor and a noise-reducing cap, according to some embodiments according to the disclosure;

FIG. 2 shows the sequence of operations to create the clean Raman spectrum, according to some embodiments according to the disclosure;

FIG. 3 is a graph showing the effect that the disclosed method has on the resulting Raman spectrum, according to some embodiments according to the disclosure;

FIG. 4 comprises graphs showing the effect that the disclosed method has on the measurement of stable glucose concentration in light environment in comparison with standard Raman, according to some embodiments of the disclosure;

FIG. 5 is a graph showing the effect that the disclosed method has on the measurement of stable lactate concentration in light environment in comparison with standard Raman, according to some embodiments of the disclosure; and

FIG. 6 comprises three graphs showing the effect that the disclosed method has on the measurement of stable glucose and lactate concentrations, of viable cells density (VCD) in a cell culture run in a normal laboratory environment in comparison with standard Raman and in reference to off-line reference values, according to some embodiments of the disclosure.

### DETAILED DESCRIPTION

Embodiments of the present disclosure describe the system and methods for reducing stray light noise used in the generation of Raman spectrums.

In many applications, such as bioprocessing applications, it is important to carefully and accurately monitor the materials within the bioreactor.

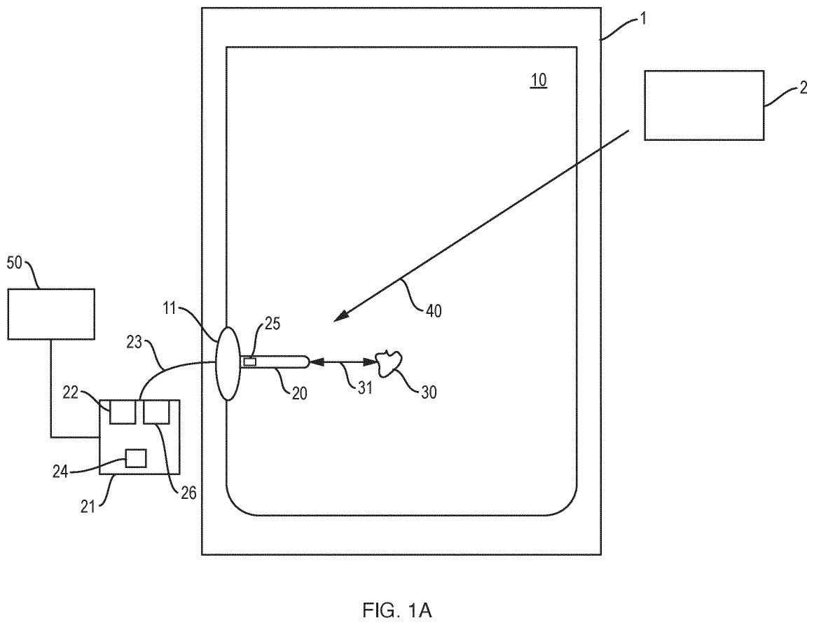

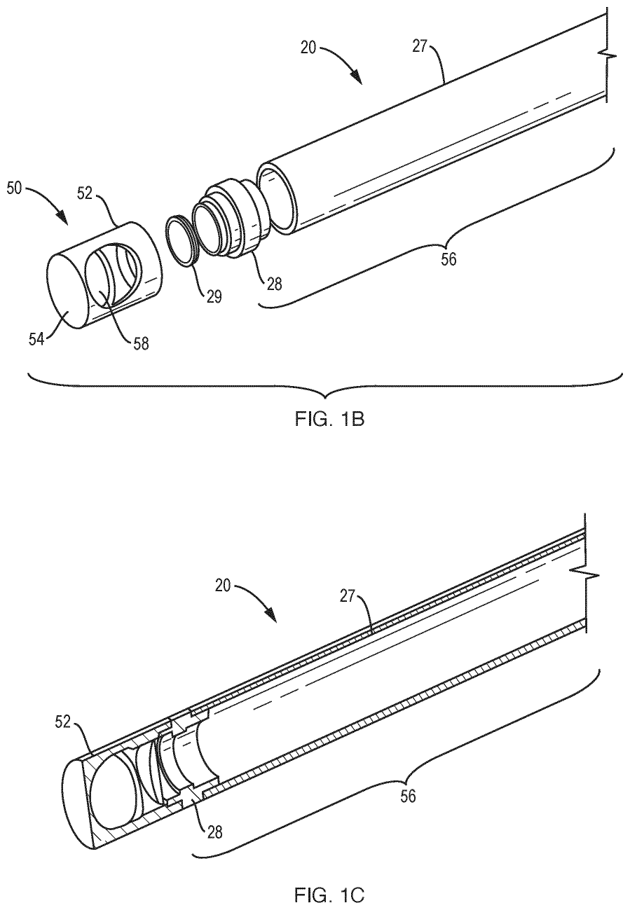

FIG. 1 illustrates a bioreactor that includes a Raman probe sensor and a noise-reducing cap, according to some embodiments according to the disclosure. FIG. 1A shows a representative bioreactor 1. The bioreactor 1 may be controlled by a bioreactor controller 2. The bioreactor controller 2 may control the various valves, spargers, impellers and other functions of the bioreactor 1.

A bioreactor bag 10 is typically inserted in the bioreactor 1. The bioreactor bag 10 may have a plurality of ports to allow the introduction of various sensors, actuators, spargers or other mechanisms into the interior of the bioreactor bag 10. In this illustration, an optical Raman probe sensor 20 enters the interior of the bioreactor bag 10 through a port 11. The optical Raman probe sensor 20 includes a tube with a window, e.g., a sapphire window. The optical Raman probe sensor 20 also optionally includes a connection thread that is compatible with bioreactors, such as PG13.5. In some embodiments, the tube of the optical Raman probe sensor 20 has a maximum external diameter of 12 mm. The optical Raman probe sensor 20 is immersed in a material contained within the bioreactor bag 10. The optical Raman probe sensor 20 projects a laser beam along an optical axis 31. The laser beam passes through the tube, the sapphire window and into the bioreactor bag 10. The optical Raman probe sensor 20 also receives scattering light from a target 30, which may be a molecule or group of molecules. The scattering light travels along a collection field of view and enters the tip of the optical Raman probe sensor 20. The optical Raman probe sensor 20 may include an optical assembly 25 of lenses and filters, to collect the optical signals from the target 30.

The optical Raman probe sensor 20 is connected to a Raman analyzer 21, which is exterior to the bioreactor 1, using a conduit 23. The Raman analyzer 21 may include a laser 22, which generates a laser beam that travels through a conduit 23 to the optical Raman probe sensor 20. This conduit 23 may be a fiberoptic cable. The Raman analyzer 21 may include an optical detector 26, which may include a CCD or photodetector. The Raman analyzer 21 also includes a processing unit 24 to control the laser 22 and interpret the output from the optical detector 26.

A controller 50 may be in communication with the Raman analyzer 21. The controller 50 may include a processing unit and an associated memory device. The processing unit may be any suitable component, such as a microprocessor, embedded processor, an application specific circuit, a programmable circuit, a microcontroller, or another similar device. This memory device contains the instructions, which, when executed by the processing unit, enable the controller 50 to perform the functions described herein. This memory device may be a non-volatile memory, such as a FLASH ROM, an electrically erasable ROM or other suitable devices. In other embodiments, the memory device may be a volatile memory, such as a RAM or DRAM, or any non-transitory computer readable storage media.

The controller 50 may receive data from the Raman analyzer 21 and provide commands or instructions to the Raman analyzer 21. In the embodiment shown in FIG. 1, the controller 50 is separate from the Raman analyzer 21. However, in other embodiments, these two components may be combined. In other embodiments, the controller 50 may transmit processed data to the bioreactor controller 2.

As noted above, Stokes Raman scattering occurs much less frequently than Rayleigh scattering, and is consequently very sensitive to noise. Therefore, ambient light 40 that enters the optical Raman probe sensor 20 may adversely affect the accuracy of the detection. This ambient light may be sunlight, moonlight, room lighting or other types of lighting. One way to address this is to quantify the amount of ambient light that enters the optical Raman probe sensor 20 and remove this background noise component from the Raman spectrum.

In normal operation, the Raman analyzer 21 enables a laser 22 that is disposed in the Raman analyzer 21. Light from the laser 22 travels to the optical Raman probe sensor 20 via the conduit 23. The light from the laser 22 causes molecules in the optical axis 31 of the laser 22 to become excited, producing Rayleigh scattering, Stokes Raman scattering and anti-Stokes Raman scattering. The light that is then received by the optical assembly 25 of the optical Raman probe sensor 20. The data from the optical Raman probe sensor 20 is then transmitted to the optical detector 26 disposed within the Raman analyzer 21, which may generate the Raman spectrum. This process may be referred to as a Raman signal acquisition measurement and the result of this process may be referred to as a Raman spectrum.

In another mode, the Raman analyzer 21 does not enable the laser 22. However, as before, data from the optical Raman probe sensor 20 is transmitted to the Raman analyzer 21, which may create the Raman spectrum. In this mode, any signal received by the optical detector 26 in the Raman analyzer 21 through the optical Raman probe sensor 20 is the result of background noise. Thus, this process is referred to as a background noise acquisition measurement and the result of this process may be referred to a background noise spectrum.

FIGS. 1A-1C show at least one embodiment, according to the disclosure. FIG. 1B shows an exploded view of this embodiment, while FIG. 1C shows a cross-section of an assembled sensor. In some embodiments, the optical Raman probe sensor 20 is enclosed in a tube 56 that comprises two parts; a tube body 27 and a tube head 28. The tube body 27 may comprise a hollow tube. The tube head 28 is affixed to the tube body 27, such as by welding. The tube head 28 comprises a sapphire window and an optical lens 29. Further, the exterior surface of the tube head 28 includes a thread to receive a cap 50. In some embodiments, cleaning may be desirable and the capability to remove the cap 50 is useful. Also, in some embodiments, the tube head 28 has threads on its exterior surface near the distal end.

The cap 50 includes a thread on the interior surface of a cylindrical body 52. In operation, the cap 50 is screwed onto the tube head 28. The cap 50 may be removed for easier cleaning. Further, in some embodiments, the cap 50 may be considered a disposable component such that a new cap 50 is installed on the tube head 28 before each use. Further, this configuration allows the possibility to choose a cap design according to the application without changing other portions of the optical Raman probe sensor 20.

In some embodiments, the length of the cap 50 may be a design decision. For example, the cap 50 may be designed such that the distance from the tip of the optical Raman probe sensor 20 to a closed end 54 is between 1 and 10 cm, although other dimensions are also possible. Openings 58 are shown as being two circular apertures. However, the disclosure is not limited to this embodiment. Rather, the openings 58 may be circular, oval, rectangular or any other shape. These processes may be used in conjunction with each other to generate a clean Raman spectrum.

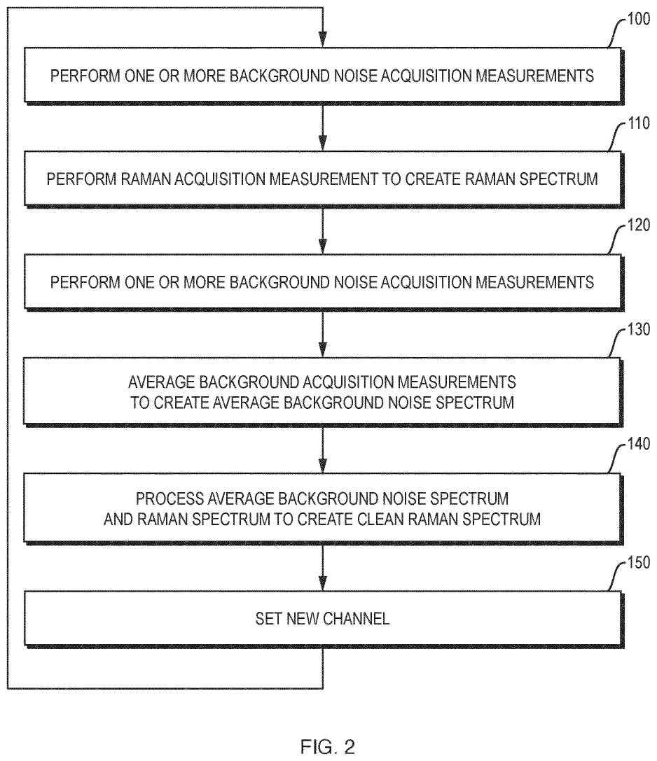

Specifically, FIG. 2 shows a flowchart illustrating the sequence of operations of the controller 50 and the Raman analyzer 21, to create clean Raman spectra. First, as shown in Box 100, one or more background noise acquisition measurements may be performed. In certain embodiments, the number of background noise acquisition measurements may be as large as 100. In other embodiments, a smaller number of background noise acquisition measurements may be performed. As noted above, this process is performed while the laser 22 is disabled.

Next, as shown in Box 110, one or more Raman acquisition measurements are performed. As described above, this involves enabling the laser 22 and detecting the emitted optical signals using the optical detector 26. The Raman analyzer 21 may then create a Raman spectrum from the output of the optical detector 26. In some embodiments, a plurality of Raman acquisition measurements are performed to create the Raman spectrum. In some embodiments, ten or more Raman acquisition measurements are performed.

Next, as shown in Box 120, one or more background noise acquisition measurements may be performed after the Raman signal acquisition measurement is performed. In certain embodiments, as was done with the background noise acquisition measurement that were performed before the Raman signal acquisition measurement, the number of background noise acquisition measurements may be as large as one hundred. In other embodiments, a smaller number of background noise acquisition measurements may be performed. In other embodiments, no background noise acquisition measurements may be performed after Raman acquisition measurement.

Next, as shown in Box 130, the background noise spectrums obtained from the background noise acquisition measurements may be averaged together and used to create an average background noise spectrum. In certain embodiments, background noise spectrums are generated from background noise acquisition measurements taken before the Raman signal acquisition measurement and background noise acquisition measurements taken after the Raman signal acquisition measurement. In other embodiments, background noise acquisition measurements are only performed before or after the Raman signal acquisition measurement. In these embodiments, one of Box 100 or Box 120 may be omitted.

In Box 140, the average background noise spectrum and the Raman spectrum are processed to create a clean Raman spectrum, which has reduced background noise. In certain embodiments, the average background noise spectrum is subtracted from the Raman spectrum to create the clean Raman spectrum. In other embodiments, other denoising algorithms may utilize the background noise spectrums and the Raman spectrum to create the clean Raman spectrum.

The operations described in Boxes 130 and 140 may be performed using the controller 50 or a different controller. For example, a different controller that is part of the same network as the Raman analyzer 21 may be used to perform these operations.

If there are multiple channels that are being analyzed, the new channel is set, as shown in Box 150, and the sequence is repeated.

The clean Raman spectrum can be used in many ways. For example, the clean Raman spectrum may be processed and analyzed by mathematical advanced tools in order to determine the composition of the medium contained in the bioreactor bag 10.

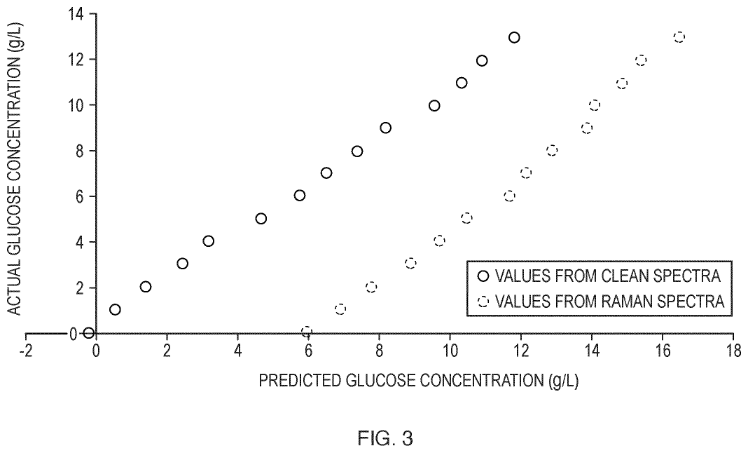

The embodiments described above in the present application may have many advantages. FIG. 3 is a graph showing the effect that the disclosed method has on the resulting Raman spectrum, according to some embodiments according to the disclosure.

In many applications, the optical Raman probe sensor 20 is disposed in glass bioreactors or in plastic bioreactor bags that are not fully opaque to ambient light. As a result, when Raman spectra are generated, the ambient light may affect the results. In one experiment, varying concentrations of glucose, from 0 to 13 g/L, were added to a bioreactor. At each concentration, Raman measurements were performed. A first set of the Raman measurements were performed with ambient light entering the bioreactor. These Raman measurements were then processed in the traditional manner, resulting in the data points in FIG. 3 labelled “Values from Raman Spectra.” These data points are the predicted glucose concentration based on the Raman spectra. Note that there is a large offset between the actual glucose concentration and the glucose concentration predicted based on the Raman spectra. Additionally, at each concentration, the sequence shown in FIG. 2 was performed, resulting in clean Raman spectra. The glucose concentrations derived from these clean Raman spectra are represented by the data points labelled “Values from Clean Spectra.” Note that the predicted glucose concentration based on the clean spectra is nearly identical to the actual glucose concentration. Thus, this technique is effective in reducing the effects of background noise.

The straylight management comprises, for e.g., a light-reducer cap, as described above, having a closed end and one or more openings is attached to the tip of an optical Raman probe sensor. The cap serves to block stray light noise from entering the tip of the sensor. In this way, Raman spectra may be more accurate and consistent. Further, the cap may be permanently affixed or removably attached to the sensor. In some embodiments, a reflective surface may be included on the interior surface of the closed end of the cap. This reflective surface may reflect Raman scattering light toward the tip, enhancing the received signal.

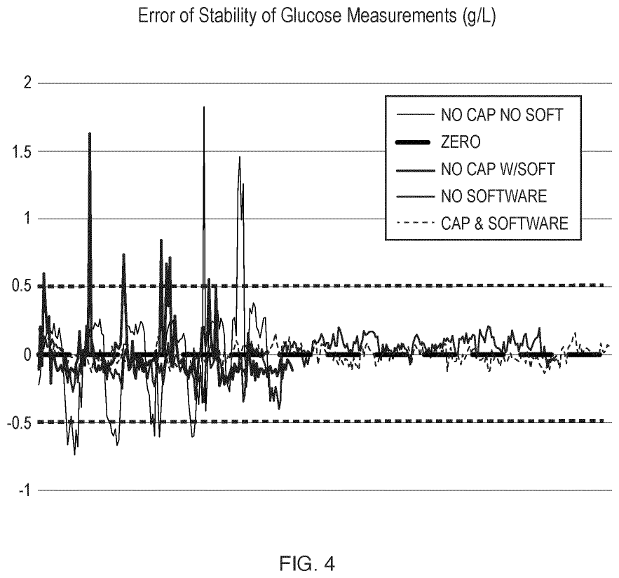

FIG. 4 comprises graphs showing the effect that the disclosed method has on the measurement of stable glucose concentration in light environment in comparison with standard Raman, according to some embodiments of the disclosure. FIG. 4 compares various straylight conditions and measurements thereof, according to some embodiments of the disclosure. A first graph demonstrates a curve showing glucose measurement data points using a standard Raman probe. A second curve shows glucose measurement data points using an advanced Raman probe with its light-reducer cap. A third graph demonstrates a third curve showing glucose measurement data points using an advanced Raman probe with its light-reducer cap and applying the software noise reduction filter. A fourth curve shows glucose measurement data points using an advanced Raman probe using the software noise reduction filter only. As evidenced, without the straylight management implemented on advanced Raman, i.e., the light-reducer cap and the subtraction of the averaged background signal, the noise is as high as 1.5 g/L. Using the straylight management, the noise is 0.2 g/L or less. The straylight management comprises, for e.g., a light-reducer cap having a closed end and one or more openings is attached to the tip of an optical Raman probe sensor. The cap serves to block stray light noise from entering the tip of the sensor. In this way, Raman spectra may be more accurate and consistent. Further, the cap may be permanently affixed or removably attached to the sensor. In some embodiments, a reflective surface may be included on the interior surface of the closed end of the cap. This reflective surface may reflect Raman scattering light toward the tip, enhancing the received signal.

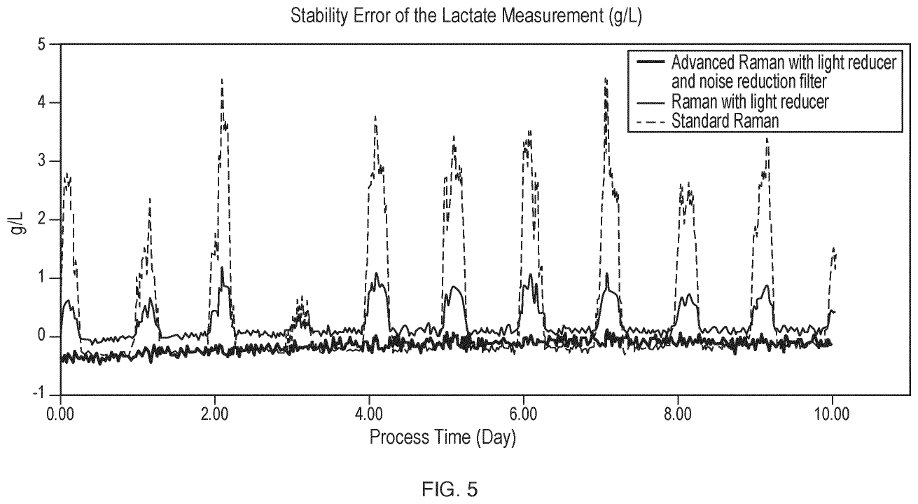

FIG. 5 is a graph showing the effect that the disclosed method has on the measurement of stable lactate concentration in light environment in comparison with standard Raman, according to some embodiments of the disclosure. FIG. 5 compares various straylight conditions and measurements thereof, according to some embodiments of the disclosure. A first curve shows lactate measurement data points using an advanced Raman probe with its light-reducing cap and applying the software noise reduction filter. A second curve shows lactate measurement data points only using an advanced Raman probe with its light-reducing cap. A third curve shows lactate measurement data points using a standard Raman probe. As evidenced, without the straylight management implemented on advanced Raman solution, i.e., the cap and the subtraction of the averaged background signal, the noise is as high as 4.0 g/L. Using the straylight management, the noise is again 0.2 g/L or less. The data demonstrate more than 70% reduction in noise when the light-reducer cap is used.

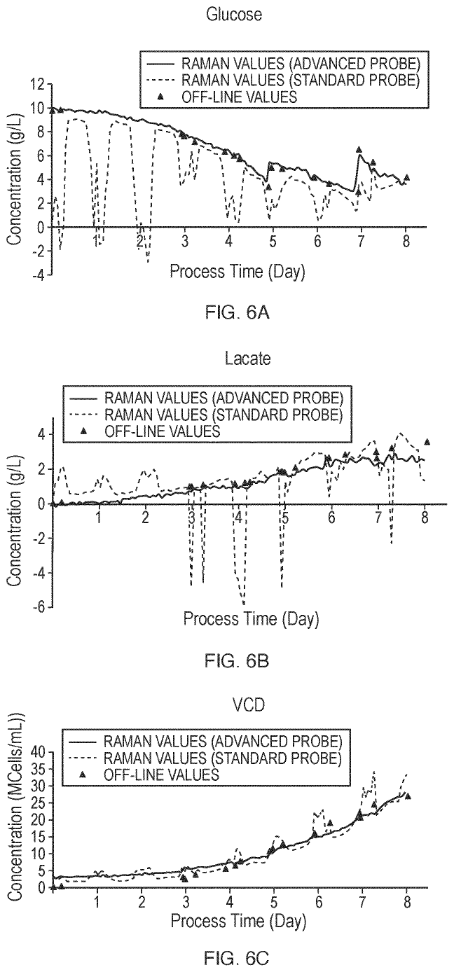

FIG. 6 comprises three graphs showing the effect that the disclosed method has on the measurement of stable glucose and lactate concentrations, of viable cells density (VCD) in a cell culture run in a normal laboratory environment in comparison with standard Raman and in reference to off-line reference values, according to some embodiments of the disclosure. FIG. 6 compares measurements from different Raman probes thereof in a fed batch cell culture running during eight days in various straylight conditions, as depicted for measuring glucose, lactate and viable cell density, according to embodiments of the disclosure.

FIG. 6A shows a first graph depicting measurement of glucose concentration using an advanced Raman probe with its light-reducer cap and with the software noise reduction filter in comparison with a standard Raman probe and in reference to off-line reference values.

FIG. 6B shows a second graph depicting measurement of lactate concentration using an advanced Raman probe with its light-reducer cap and with the software noise reduction filter in comparison with a standard Raman probe and in reference to off-line reference values.

FIG. 6C shows a third graph depicting measurement of viable cell density using an advanced Raman probe with its light-reducer cap and with the software noise reduction filter in comparison with a standard Raman probe and in reference to off-line reference values. The third graph demonstrates that the disclosure applies not only to nutrients and VCD but also other critical parameters of a cell culture. For example, it is shown that without the straylight management disclosed herein, the VCD predictions are aberrant. An improved glucose control helps to manage a better cell growth and also the cell viability (~living cells/dead cells). A more accurate glucose measurement can be and often is a key factor in obtaining improved process control. The lactate is initially not a nutrient but more a waste of cells when they produce antibodies and is also an indicator of cell metabolism. An improved accuracy on the lactate measurements therefore helps to better understand if cells are having a good culture media to produce antibodies.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method of measuring Raman scattering, comprising:
performing one or more noise acquisition measurements using a Raman analyzer, wherein the one or more noise acquisition measurements are performed while a laser within the Raman analyzer is disabled;
performing one or more Raman signal acquisition measurements to create a Raman spectrum, wherein the Raman signal acquisition measurement is performed while the laser within the Raman analyzer is enabled;
averaging the one or more noise acquisition measurements to create an average background noise spectrum; and
processing the average background noise spectrum and the Raman spectrum to create a clean Raman spectrum.

2. The method of claim 1, wherein the average background noise spectrum is subtracted from the Raman spectrum to crate the clean Raman spectrum.

3. The method of claim 1, wherein more than one Raman signal acquisition measurement is performed and results from the more than one Raman signal acquisition measurements are averaged to create the Raman spectrum.

4. The method of claim 1, wherein at least one of the one or more noise acquisition measurements is performed before the Raman signal acquisition measurement.

5. The method of claim 1, wherein at least one of the one or more noise acquisition measurements is performed after the Raman signal acquisition measurement.

6. The method of claim 1, wherein more than one noise acquisition measurement is performed, and at least one of the noise acquisition measurements is performed before the Raman signal acquisition measurement and at least one of the noise acquisition measurements is performed after the Raman signal acquisition measurement.

7. The method of claim 1, wherein the Raman analyzer includes having a light-reducing cap thereon.

8. A system for measuring Raman scattering, comprising:
an optical Raman probe sensor;
a Raman analyzer, comprising an optical detector and a laser, the Raman analyzer in communication with the optical Raman probe sensor via a conduit; and
a controller, wherein the controller:
disables the laser and performs one or more noise acquisition measurements;
enables the laser and performs one or more Raman signal acquisition measurements to generate a Raman spectrum;
averages the one or more noise acquisition measurements to generate a noise spectrum; and
processes the noise spectrum and the Raman spectrum to create a clean Raman spectrum.

9. The system of claim 8, wherein the controller subtracts the noise spectrum from the Raman spectrum to create the clean Raman spectrum.

10. The system of claim 8, wherein more than one Raman signal acquisition measurements are performed and the controller averages results from the more than one Raman signal acquisition measurements to create the Raman spectrum.

11. The system of claim 8, wherein the controller performs at least one of the one or more noise acquisition measurements before the Raman signal acquisition measurement.

12. The system of claim 8, wherein the controller performs at least one of the one or more noise acquisition measurements after the Raman signal acquisition measurement.

13. The system of claim 8, wherein the controller performs more than one noise acquisition measurement, and at least one of the noise acquisition measurements is performed before the Raman signal acquisition measurement and at least one of the noise acquisition measurements is performed after the Raman signal acquisition measurement.

14. The system of claim 8, further comprising a light-reducing cap on the Raman probe sensor.
